(19) United States
(12) Patent Application Publication
(10) Pub. No.: US 2024/0061480 A1
(43) Pub. Date: Feb. 22, 2024

(54) METHOD AND DEVICE FOR PROCESSING OVERHEAT AND STORAGE MEDIUM

(71) Applicant: SPREADTRUM COMMUNICATIONS (SHANGHAI) CO., LTD., Shanghai (CN)

(72) Inventors: Xiaoyu CHEN, Shanghai (CN); Lifeng HAN, Shanghai (CN)

(21) Appl. No.: 18/260,693

(22) PCT Filed: Feb. 17, 2022
(86) PCT No.: PCT/CN2022/076562

§ 371 Date: Jul. 7, 2023

(30) Foreign Application Priority Data
Jan. 8, 2021 (CN) 202110025138.7

(51) Int. Cl. G06F 1/20; H04W 76/27

(52) U.S. Cl. CPC G06F 1/206; H04W 76/27

(57) ABSTRACT

Disclosed are a method and device for processing overheat and a storage medium. The method for processing overheat includes: obtaining configuration indication information in response to detecting overheat of a terminal, where the configuration indication information is indicative of a working-state configuration of an AI model; and adjusting a working state of a corresponding AI model based on the configuration indication information.

### CROSS-REFERENCE TO RELATED APPLICATION(S)

This application is a National Stage of International Application No. PCT/CN2022/076562, field Feb. 17, 2022, which claims priority to Chinese Patent Application No. 202110025138.7, filed Jan. 8, 2021, the entire disclosure of which are hereby incorporated by reference.

### TECHNICAL FIELD

This disclosure relates to the field of communications, and in particular, to a method and device for processing overheat and a storage medium.

### BACKGROUND

With the wide application of an artificial intelligence (AI) technology in a communication network, the application of the AI technology on a terminal is becoming increasingly popular.

However, performing training and reasoning on an AI model at a terminal can easily cause overheat of the terminal. Even if training and reasoning on the AI model are carried out on a network side or a cloud side, the terminal participates in such a centralized AI training and reasoning process, and the overheat of the terminal still occurs. The overheat of the terminal will easily result in frequency reduction and lagging, which affects user experience.

### SUMMARY

A method for processing overheat is provided in implementations of the present disclosure. The method for processing overheat includes: obtaining configuration indication information in response to detecting overheat of a terminal, where the configuration indication information is indicative of a working-state configuration of an AI model; and adjusting a working state of a corresponding AI model based on the configuration indication information.

A storage medium is further provided in implementations of the present disclosure. The storage medium is a non-volatile storage medium or a non-transitory storage medium, and the storage medium is configured to store a computer program which, when executed by a processor, is operable with the processor to perform operations of any of the above methods for processing overheat.

A device for processing overheat is further provided in implementations of the present disclosure. The device for processing overheat includes a memory and a processor, the memory is configured to store a computer program capable of running on the processor, and the processor, when running the computer program, is configured to perform operations of any of the above methods for processing overheat.

### BRIEF DESCRIPTION OF THE DRAWINGS

FIG. 1 is a schematic flowchart of a method for processing overheat of a terminal provided in some implementations of the present disclosure.

FIG. 2 is a schematic flowchart of a method for processing overheat of a terminal provided in other implementations of the present disclosure.

FIG. 3 is a schematic structural diagram of a device for processing overheat of a terminal provided in some implementations of the present disclosure.

FIG. 4 is a schematic structural diagram of a device for processing overheat of a terminal provided in other implementations of the present disclosure.

FIG. 5 is a schematic structural diagram of a device for processing overheat of a terminal provided in other implementations of the present disclosure.

### DETAILED DESCRIPTION

As described in the background, performing training and reasoning on an AI model at a terminal can easily cause overheat of the terminal. Even if training and reasoning on the AI model are carried out on a network side or a cloud side, the terminal participates in such a centralized AI training and reasoning process, and the overheat of the terminal still occurs. The overheat of the terminal will easily result in frequency reduction and lagging, which affects user experience.

In order to solve the described problem, in implementations of the present disclosure, when overheat of a terminal is detected, configuration indication information is obtained; based on a working-state configuration of an AI model indicated in the configuration indication information, a working state of the AI model is adjusted. By adjusting the working state of a running AI model, the overheat of the terminal is expected to be alleviated or eliminated.

To make objectives, elements, and beneficial effects of implementations of the present disclosure clearer and more comprehensible, implementations of the present disclosure will be described in the following in detail with reference to accompanying drawings.

A method for processing overheat is provided in implementations of the present disclosure. The method for processing overheat may be performed by a terminal itself, and may also be performed by a chip such as a control chip, a processing chip, a baseband chip or other various proper components that can be used in the terminal. The terminal may also be referred to as a user equipment (UE), and the terminal may be various appropriate terminals, such as a mobile phone, a computer, an Internet-of-things (IoT) device, and a vehicle-mounted device, but is not limited thereto.

Compared with the related art, technical solutions of implementations of the present disclosure have the following beneficial effects.

When overheat of a terminal is detected, configuration indication information is obtained, a working state of an AI model is adjusted based on a working-state configuration of the AI model indicated in the configuration indication information, and thus the overheat of the terminal is expected to be alleviated or eliminated by adjusting the working state of the running AI model.

Further, the configuration indication information is static information pre-configured by a network side, and the static information includes configuration permission information about the AI model. Therefore, when the terminal is overheated, the terminal can locally obtain static information from the terminal, and adjust the working state of the corresponding AI model based on a configuration permission for the AI model indicated in the configuration permission information about the AI model in the static information. In this way, the overheat of the terminal can be solved without interacting with the network side, thereby improving efficiency of solving the overheat of the terminal.

Further, when the overheat of the terminal is alleviated or eliminated, the working state of the AI model is re-adjusted based on the configuration permission information about the AI model, so as to configure the working state of the AI model without interacting with the network side, thereby restoring working states of some AI models, for example, restarting an AI model that is turned off when the terminal is overheated, or improving accuracy of an AI model an accuracy of which is reduced when the terminal is overheated. As such, network communication performance of the terminal is guaranteed, and the user experience is improved.

Further, the configuration indication information may include dynamic information. When the terminal is overheated, the dynamic information configured by the network side is obtained from the network side, which is beneficial for the network side to configuring the dynamic information for the terminal according to an overall situation of the network side.

Further, reported first overheating assistance information can include one or more of: first overheating indication information, suggestion information about an AI-model configuration, available calculation resource information, etc., and the terminal can indicate to the network side that the terminal is overheated due to running of the AI model through the first overheating assistance information. For some terminals with certain capabilities, some suggestions can be made to the network side through the suggestion information about an AI-model configuration or an actual situation of the terminal itself can be given to the network side through the available calculation resource information, which is beneficial for the network side to configuring the dynamic information suitable for the terminal according to an actual requirement or the actual situation of the terminal.

Further, when the overheat of the terminal is alleviated or eliminated, additional dynamic information configured by the network side is obtained from the network side, and the working state of the AI model is re-adjusted based on the additional dynamic information, thereby restoring working states of some AI models, for example, restarting an AI model that is turned off when the terminal is overheated, or improving accuracy of an AI model an accuracy of which is reduced when the terminal is overheated. As such, network communication performance of the terminal is guaranteed, and the user experience is improved.

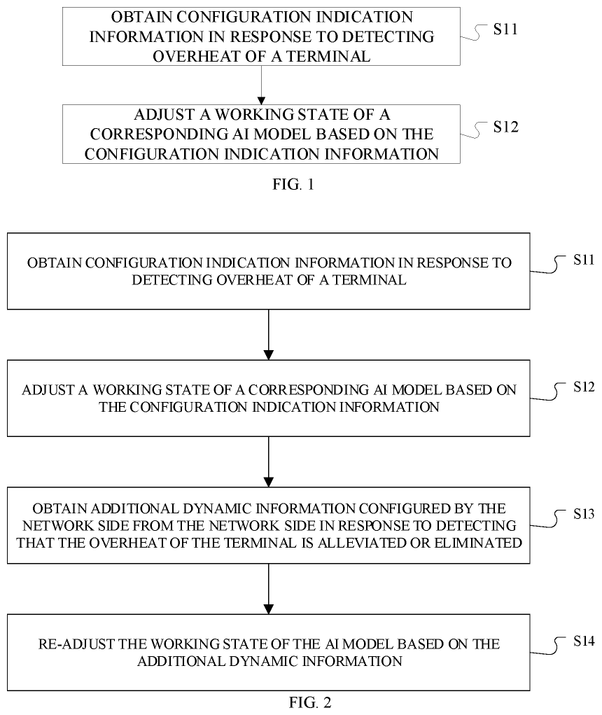

Refer to FIG. 1, which is a schematic flowchart of a method for processing overheat provided in some implementations of the present disclosure. The method for processing overheat may specifically include the following.

At S11, in response to detecting overheat of a terminal, configuration indication information is obtained.

In a specific implementation, the obtained configuration indication information may be indicative of a working-state configuration of an AI model.

It is found through research that, when the terminal performs training and reasoning on an AI model, calculation resources of the terminal may be consumed, thereby result in increase of power consumption of the terminal. The increase of the power consumption of the terminal correspondingly leads to increase of the temperature of the terminal. In addition, even if training and reasoning of the AI model are carried out on a network side or a cloud side, the terminal participates in such a centralized AI training and reasoning process, and needs to upload a large amount of data, thereby resulting in increase of transmission power consumption of the terminal. When the transmission power consumption of the terminal increases, the temperature of the terminal tends to rise. The number of running AI models is related to the temperature of the terminal, and more running AI models will cause overheat of the terminal more easily.

In some implementations, the overheat of the terminal may be determined based on the temperature of the terminal. For example, when the temperature of the terminal is greater than a set temperature threshold, the overheat of the terminal can be determined.

It is found through research that, a running AI model generally needs to occupy corresponding calculation resources, and generally, when a large number of AI models are running or a running AI model requires a large amount of calculation resources, the graphics processing unit (GPU) is occupied more. However, the calculation resources occupied by the running AI model is related to the temperature of the terminal, and the more calculation resources occupied by the running AI model, the more easily will the overheat of the terminal will occur. However, the calculation resources required for the running AI model in the terminal is related to the occupancy of the GPU in the terminal, and therefore, a running condition of the AI model and whether the terminal is overheated can be inferred from the occupancy of the GPU.

In some implementations, whether the terminal is overheated may be determined based on the occupancy of the GPU in the terminal and the total capacity of the GPU. For example, an occupancy rate of the GPU is calculated based on the occupancy of the GPU and the total capacity of the GPU, and when the occupancy rate of the GPU is greater than a set threshold, the overheat of the terminal is determined.

It should be noted that the foregoing examples are only for illustrative purpose, and the overheat of the terminal can be determined in other ways, which are not elaborated herein.

In a specific implementation, the overheat of the terminal may be overheat of the entire terminal, or overheat of some systems or components in the terminal, such as overheat of a chip, overheat of a transmission module, overheat of a central processing unit (CPU), overheat of a GPU, overheat of a baseband chip, or the like.

In a specific implementation, when the method for processing overheat is performed by a chip or another appropriate component, the chip or the another appropriate component may receive a detection result of the overheat of the terminal from another coupled component. For example, the chip or the another appropriate component may receive temperatures of some specified components or systems in the terminal sent from a coupled temperature detection apparatus. The chip or the another proper component itself may also be provided with a temperature detection apparatus, and determine the overheat of the terminal based on a temperature detected by the temperature detection apparatus configured on the chip or the another proper component itself.

At S12, a working state of a corresponding AI model is adjusted based on the configuration indication information.

In a specific implementation, after the configuration indication information is obtained, the working state of the corresponding AI model can be adjusted based on the working-state configuration of the AI model indicated in the configuration indication information.

In some implementations, adjusting the working state of the corresponding AI model may include at least one of: keeping some AI models turned on, turning some AI models off, reducing accuracy of some AI models, etc.

It can be seen from the above that when the overheat of the terminal is detected, the configuration indication information is obtained, and the working state of the AI model is adjusted based on the working-state configuration of the AI model indicated in the configuration indication information. By adjusting the working state of the running AI model, the overheat of the terminal can be expected to be alleviated or eliminated.

In a specific implementation, the configuration indication information obtained at S11 may be static information pre-configured by the network side and obtained from the terminal.

Specifically, in response to detecting the overheat of the terminal, the static information pre-configured by the network side may be obtained locally.

The static information may include configuration permission information about the AI model, and the configuration permission information about the AI model is indicative of a configuration permission for the AI model. The terminal may adjust the working state of the AI model based on the configuration permission for the AI model indicated in the configuration permission information about the AI model. By changing the working state of the AI model at the terminal side, the overheat of the terminal is solved.

According to different execution subjects of the method for processing overheat, objects having permission to configure the AI model are different. When an execution subject of the method for processing overheat is the terminal, the terminal has the permission to configure the AI model. When the execution subject of the method for processing overheat is a chip or some other components, the chip or some other components have a control permission for the AI model.

Further, after the working state of the corresponding AI model is adjusted, in response to detecting that the overheat of the terminal is alleviated or eliminated, the working state of the AI model can be re-adjusted based on the configuration permission information about the AI model. For example, re-adjusting the working state of the AI model may include restarting some AI models turned off when the terminal is overheated, improving accuracy of some AI models accuracy of which is reduced when the terminal is overheated, increasing the amount of data uploaded by the terminal, etc. By adjusting the configuration of the AI model of the terminal, the performance of the communication network of the terminal is ensured, and the user experience is improved.

In a specific implementation, whether the overheat of the terminal is alleviated or eliminated can be determined in many ways.

In some implementations, whether the overheat of the terminal is alleviated or eliminated may be determined based on a duration. For example, if the working state of a corresponding AI model is adjusted to reach a set duration, the overheat of the terminal is determined to be alleviated or eliminated.

Because degrees corresponding to alleviation of overheat and elimination of overheat are different, alleviation of overheat and elimination of overheat may be specifically distinguished by setting set durations. When the working state of the corresponding AI model is adjusted to reach a first set duration, determine that the overheat of the terminal is alleviated. When the working state of the corresponding AI model is adjusted to reach a second set duration, determine that the overheat of the terminal is eliminated, where the first set duration is less than the second set duration.

In some implementations, whether the overheat of the terminal is alleviated or eliminated may be determined based on the temperature of the terminal. For example, when the temperature of the terminal is lower than a first threshold temperature, the overheat of the terminal is determined to be alleviated; and when the temperature of the terminal is lower than a second threshold temperature, the overheat of the terminal is determined to be eliminated, where the first threshold temperature is higher than the second threshold temperature.

It should be noted that, whether the overheat of the terminal is alleviated or eliminated may also be determined in other ways, which is not limited herein.

In some non-limiting implementations, the configuration permission for the AI model may include at least one of the following: configuration permission for turning on and turning off the AI model, configuration permission for an off duration of the AI model, configuration permission for accuracy adjustment of the AI model, configuration permission for accuracy-level adjustment of the AI model, or the like.

The configuration permission for turning on and turning off the AI model refers to that for an AI model for which the terminal has configuration permission for turning on and turning off the AI model, whether to stop using the AI model or whether to turn on the AI model can be decided by the terminal independently. When the terminal is overheated, the terminal may decide independently to turn off the AI model for which the terminal has the configuration permission for turning on and turning off the AI model. Alternatively, when the overheat of the terminal is alleviated or eliminated, the terminal may decide independently to turn on the AI model for which the terminal has the configuration permission for turning on and turning off the AI model.

Further, when the terminal has the configuration permission for an off duration of the AI model, the terminal can determine independently the off duration of the AI model under the premise of the maximum off duration allowed by the configuration permission for the off duration.

Further, for an AI model for which the terminal has the configuration permission for the off duration, timing can be performed after the AI model is turned off, and the AI model can be automatically started after a set maximum off duration is reached, thereby guaranteeing the communication performance of the terminal.

For an AI model for which the terminal does not have the configuration permission for turning on and turning off the AI model, the terminal is unable to decide independently whether to stop using the AI model. When the terminal is overheated, the AI model, for which the terminal does not have configuration permission for turning on and turning off the AI model, should be retained, the AI model for which the terminal does not have the configuration permission for turning on and turning off the AI model is kept running, and the terminal is unable to decide whether to turn off the AI model independently.

Further, for AI models for which the terminal does not have configuration permission for turning on and turning off the AI models, the terminal is required to negotiate with the network side to turn off or turn on the AI models, and the working state of these AI models can be adjusted based on an indication of the network side.

The configuration permission for accuracy adjustment of the AI model refers to that for an AI model for which the terminal has the configuration permission for accuracy adjustment, the terminal can determine independently accuracy adjustment of the AI model. When the terminal is overheated, the terminal may decide independently to reduce the accuracy of the AI model for which the terminal has the configuration permission for accuracy adjustment. Alternatively, when the overheat of the terminal is alleviated or eliminated, the terminal may decide independently to improve the accuracy of the AI model for which the terminal has the configuration permission for accuracy adjustment.

Further, when the terminal has the configuration permission for accuracy-level adjustment of the AI model, the terminal can configure an accuracy level of the AI model based on the indicated configuration permission for accuracy-level adjustment. When the terminal is overheated, the terminal can reduce the accuracy level of the AI model based on the indicated configuration permission for accuracy-level adjustment. Alternatively, when the overheat of the terminal is alleviated or eliminated, the terminal can increase the accuracy level of the AI model based on the indicated configuration permission for accuracy-level adjustment.

In a specific implementation, the configuration permission information about the AI model included in the static information configured by the network side can be indicated to the terminal in many ways, as long as specific representation of the configuration permission information about the AI model is known by each of the network side and the terminal.

For example, for the configuration permission for turning on and turning off the AI model, indicators 0 and 1 are indicative of the configuration permission for turning on and turning off the AI model. If the configuration permission information about the AI model is represented by indicator 1, it indicates that the terminal has the configuration permission for turning on and turning off the AI model. If the configuration permission information about the AI model is represented by indicator 0, it indicates that the terminal does not have the configuration permission for turning on and turning off the AI model. When the terminal is overheated, the terminal may independently stop using the AI model with the indicator being 1. The AI model with the indicator being 0 needs to be retained even if the terminal is overheated, and the terminal is unable to independently determine whether to turn off the AI model with the indicator being 0.

It should be noted that the configuration permission information corresponding to different types of configuration permissions may use different identifiers (IDs), and the configuration permission information about the AI model can be indicated in other ways based on actual requirements, which are not elaborated herein.

In a specific implementation, the network side may send the static information when configuring the AI model or updating the AI model for the terminal. The static information may be sent to the terminal as attribute information of the AI model, may also be sent to the terminal as indication information, and may also be sent to the terminal as other types of information, which is not limited herein.

In some implementations, when the network side configures AI models for the terminal, the network side may respectively send static information corresponding to each AI model, that is, each AI model corresponds to one piece of static information, and configuration permission information about the AI model contained in the static information about each AI model is applicable to said each AI model. When the terminal is overheated, static information of all AI models of the terminal needs to be obtained.

In other implementations, when the network side configures AI models for the terminal, the network side may also put configuration permission information about all AI models in one piece of static information in batches, that is, the static information includes the configuration permission information about all the AI models of the terminal. When the terminal is overheated, the terminal can obtain the configuration permission for all the AI models from the static information only by obtaining said one piece of static information.

In still other implementations, when the network side updates AI models for the terminal, static information corresponding to each AI model may be sent or updated, that is, each AI model corresponds to one piece of static information, configuration permission information about the AI model contained in the static information about each AI model is applicable to said each AI model. When the terminal is overheated, static information about all the AI models on the terminal needs to be obtained.

In still other implementations, when the network side updates AI models for the terminal, the network side may also put the configuration permission information about all the AI models in one piece of static information in batches, that is, the static information includes the configuration permission information about all the AI models of the terminal. When the terminal is overheated, the terminal can obtain the configuration permission for all the AI models from the static information only by obtaining said one piece of static information.

In a specific implementation, based on an overall configuration adjustment requirement of the network side, configuration permission for an AI model may be adjusted. When the network side needs to adjust the configuration permission for an AI model, updated static information may be sent, and the updated static information includes adjusted configuration permission information about the AI model. After receiving the updated static information, the terminal may overwrite the existing static information with the updated static information. The updated static information can be used as the static information for subsequent adjustment of the working state of the AI model.

After the terminal re-adjusts the working state of the AI model based on the configuration permission information about the AI model, the overheat of the terminal will be generally alleviated or disappear. However, if the number of running AI models for which the terminal has no configuration permission is large, even if the terminal re-adjusts the working state of the AI model based on the configuration permission information about the AI model, the overheat of the terminal may still exist.

In order to solve the problem that the terminal is still overheated after the working state of the AI model is re-adjusted, in implementations of the present disclosure, if the overheat of the terminal is still detected after the working state of the AI model is re-adjusted based on the configuration permission information about the AI model, dynamic information configured by the network side is obtained from the network side, where the dynamic information is indicative of a working-state configuration of the AI model when the terminal is overheated, the configuration indication information includes the dynamic information. After obtaining the dynamic information, the terminal may re-adjust the working state of the AI model based on the working-state configuration of the AI model when the terminal is overheated indicated in the dynamic information. By re-adjusting the working state of the AI model, the AI model of the terminal is reconfigured, so as to alleviate or eliminate the overheat of the terminal.

In some implementations, after the working state of the AI model is re-adjusted based on the configuration permission information about the AI model, if the overheat of the terminal is still detected, the terminal may be in an idle state or an inactive state currently. When the terminal is currently in the idle state or the inactive state, a connection with the network side is established, and first overheating assistance information is reported after the connection with the network side is established.

In a specific implementation, obtaining the configuration indication information at S11 may include obtaining the dynamic information configured by the network side from the network side. The configuration indication information includes the dynamic information, and the dynamic information is indicative of the working-state configuration of the AI model when the terminal is overheated. After obtaining the dynamic information, the terminal may adjust the working state of the AI model based on the working-state configuration of the AI model during overheat indicated in the dynamic information. The AI model in the terminal is reconfigured by adjusting the working state of the AI model, so as to alleviate the overheat or eliminate the overheat.

In some implementations, the network side may configure the dynamic information for the terminal in real time based on the first overheating assistance information and send the dynamic information to the terminal. Thus, the dynamic information configured for the terminal each time can meet a current practical condition of the terminal.

In other implementations, the network side may also select one configuration from multiple preset configurations based on a mapping relationship configured in a mapping table based on a pre-configured policy and mapping relationships. Different configurations correspond to different working state configurations of the AI model, dynamic information is generated based on the selected configuration, and sent to the terminal. For example, the overheat caused by different AI models correspond to different configurations, or different types of terminals correspond to different configurations. It can be understood that corresponding configurations can also be determined on the basis of other factors, and the corresponding configuration can be selected on the basis of current practical requirements during subsequent use.

In a specific implementation, the dynamic information may include at least one of the following information: an AI model to be kept on, an AI model to be turned off, an off duration of an AI model, an AI model with reduced accuracy, or a duration during which accuracy of an AI model is to be reduced.

In some implementations, the dynamic information may include ID information of the AI model and configuration ID information of the AI model, etc. The ID information of the AI model is used for identifying the AI model, and is uniquely corresponding to the AI model. The configuration ID information of the AI model is used for identifying a working-state configuration of the AI model. Different working state configurations of the AI model correspond to different configuration ID information. For example, 0 is used to identify that the AI model is turned off, and 1 is used to identify that the AI model is kept on. Thus, the working-state configuration of each AI model can be determined based on the ID of the AI model and the configuration ID information of the AI model.

In some implementations, the network side may send the configuration indication information to the terminal through radio resource control (RRC) signaling.

In a specific implementation, in response to detecting the overheat of the terminal, the first overheating assistance information is reported to the network side, so that the network side sends the dynamic information after receiving the first overheating assistance information.

In a specific implementation, the terminal may report the first overheating assistance information to the network side through the RRC signaling, and for example, the RRC signaling may be UE assistance information (UAI). In this case, the first overheating assistance information is carried in an overheating assistance information element (Overheat Assistance IE). It can be understood that the RRC signaling may also be other RRC signaling.

In a specific implementation, the first overheating assistance information may include at least one of the following information: first overheating indication information, suggestion information about an AI-model configuration, or available calculation resource information, etc.

In a specific implementation, the first overheating indication information is indicative of the overheat of the terminal, and the overheat of the terminal is related to running of the AI model. The terminal may indicate, by using the first overheating indication information, that the terminal is overheated to the network side, and a cause of the overheat of the terminal is related to factors such as an AI model running on the terminal.

In a specific implementation, the suggestion information about an AI-model configuration in the first overheating assistance information includes at least one of: a suggested AI model to be retained, a suggested AI model to be tuned off, a suggested off duration of an AI model, a suggested AI model with reduced accuracy, a suggested duration during which accuracy of an AI model is reduced, or the like.

In some implementations, the terminal may obtain the suggestion information about an AI-model configuration by determining the suggestion information about an AI-model configuration based on at least one of: configuration information of a historical AI model, calculation resources occupied by each running AI model runs, and predicted calculation resources to be reduced to alleviate overheat or eliminate overheat.

In a specific implementation, the available calculation resource information includes at least one of the following information: available calculation resources at the current moment, predicted calculation resources to be reduced to alleviate overheat or eliminate overheat, etc.

In a specific implementation, according to different actual situations of the terminal, the first overheating assistance information may include different information.

In some implementations, the first overheating assistance information can only include the first overheating indication information. When the network side receives the first overheating assistance information only including the first overheating indication information, the network side may know that the terminal is overheated due to reasons such as a large number of running AI models or too many calculation resources occupied by running AI models. The network side responds to the first overheating assistance information, configures dynamic information for the terminal, and sends the dynamic information to the terminal.

In other implementations, for a terminal capable of knowing a running condition of the AI model of the terminal, the terminal may make some reasonable suggestions to the network side when the terminal is overheated. Specifically, the first overheating assistance information reported by the terminal may include suggestion information about an AI-model configuration. The terminal may indicate, to the network side through the suggestion information about an AI-model configuration, one or more of the following information suggested by the terminal: a suggested AI model to be retained, a suggested AI model to be tuned off, a suggested off duration of an AI model, a suggested AI model with reduced accuracy, a suggested duration during which accuracy of an AI model is reduced, or the like. The network side may configure dynamic information for the terminal by considering the suggestion information about an AI-model configuration, so as to improve a matching degree between the dynamic information configured for the terminal and an actual requirement of the terminal, and help better alleviate the overheat of the terminal.

In still other implementations, for a terminal that has limited capability and is unable to provide reasonable suggestions to the network side, the terminal can calculate available calculation resources at a current moment, predicted calculation resources to be reduced to alleviate overheat or eliminate overheat, etc., and report the first overheating assistance information including one or more of: the available calculation resources at the current moment, predicted calculation resources to be reduced to alleviate overheat or eliminate overheat, etc. In this way, after receiving the first overheating assistance information, the network side may accurately learn that the terminal is overheated due to a large number of running AI models or excessive participation in AI-related network functions, and may obtain the available calculation resources of the terminal and predicted calculation resources to be reduced to alleviate or eliminate overheat. In this way, the network side may determine how to configure appropriate dynamic information for the terminal by comprehensively considering one or more of: available calculation resources of the terminal, an air interface, a base station, a capability reported by a neighboring cell, historical dynamic information that has been configured for the terminal, or the like.

It should be noted that, the first overheating assistance information, reported by the terminal based on an actual requirement of the terminal, an actual capability of the terminal, and the like, may include two or all of: the first overheating indication information, the suggestion information about an AI-model configuration, and available calculation resource information, which are not elaborated herein.

In some implementations, the terminal may currently be in an idle or inactive state when the overheat of the terminal is detected. When the terminal is currently in an idle state or an inactive state, the terminal establishes a connection with the network side, and reports the first overheating assistance information after establishing the connection with the network side.

In some non-limiting implementations, the dynamic information can further include static information, and the static information includes configuration permission information about the AI model. The configuration permission information about the AI model is indicative of a configuration permission for the AI model. In this case, the terminal may configure the working state of the AI model based on the working-state configuration of the AI model when the terminal is overheated indicated in the dynamic information. The static information may be stored locally, and when the terminal is overheated subsequently, the terminal may decide independently to adjust the working state of the AI model based on the configuration permission information about the AI model in the static information. The static information may also be used for the terminal to re-adjust the working state of the AI model based on the configuration permission information about the AI model in the static information when the overheat of the terminal is alleviated or eliminated.

For specific implementations of adjusting the working state of the AI model by the terminal based on the static information, reference may be made to related descriptions of the static information in the foregoing implementations of the present disclosure, which will not be repeated herein.

In a specific implementation, when the terminal is overheated for the first time, or the number of times that the terminal is overheated exceeds a set number of times, the network side may add the static information to the dynamic information, so as to indicate the configuration permission for the AI model to the terminal. When the terminal is overheated subsequently, the terminal may independently determine how to adjust the working state of the AI model based on the configuration permission for the AI model indicated in the static information without interacting with the network side, thereby improving overheat processing efficiency.

It should be noted that, some examples in the foregoing implementations are described by using the terminal as an execution subject. In a practical application, when the execution subject is a chip or some other components, specific execution operations are similar, and reference can be made to related descriptions in the foregoing implementations, which is not described herein again.

Referring to FIG. 2, another method for processing overheat is provided in implementations of the present disclosure. When the configuration indication information includes dynamic information, the method for processing overheat can further include operations at S13 and S14 on the basis of the method for processing overheat illustrated in FIG. 1.

At S13, when the overheat of the terminal is detected to be alleviated or eliminated, additional dynamic information configured by the network side is obtained from the network side.

In a specific implementation, the additional dynamic information is indicative of a working-state configuration of an AI model when the overheat of the terminal is alleviated or eliminated.

In a specific implementation, the additional dynamic information may include at least one of: an AI model to be turned on, an AI model information with improved accuracy, or the like.

At S14, the working state of the AI model is re-adjusted based on the additional dynamic information.

Further, operations at S13 may include: when the overheat of the terminal is detected to be alleviated or eliminated, reporting second overheating assistance information to the network side, to make the network side send the additional dynamic information after receiving the second overheating assistance information.

In a specific implementation, the terminal may report the second overheating assistance information to the network side through RRC signaling, for example, the RRC signaling may be UAI. In this case, the second overheating assistance information may be carried in the Overheating Assistance IE. It is understandable that the RRC signaling may also be other RRC signaling.

In a specific implementation, the second overheating assistance information may include at least one of: second overheating indication information, suggestion information about an AI-model configuration, and available calculation resource information, etc.

In specific implementation, the second overheating indication information is indicative of alleviation or elimination of the overheat of the terminal. That is, the terminal may indicate to the network side, through the second overheating indication information, that the overheat of the terminal is alleviated or eliminated.

In a specific implementation, the suggestion information about an AI-model configuration in the second overheating assistance information includes at least one of: a suggested AI model to be turned on, a suggested AI model with improved accuracy, etc.

In some implementations, the terminal may obtain the suggestion information about an AI-model configuration by determining the suggestion information about an AI-model configuration based on at least one of: configuration information about a historical AI model, calculation resources occupied by each running AI model, and predicted available calculation resources that do not cause overheat.

In a specific implementation, the available calculation resource information may include at least one of: available calculation resources at the current moment, predicted available calculation resources which do not cause overheat.

In a specific implementation, the second overheating assistance information may contain different information according to different actual situations of the terminal.

In some implementations, the second overheating assistance information may only include the second overheating indication information. When receiving the second overheating assistance information only including the second overheating assistance indication information, the network side can know that overheat of the terminal is alleviated or eliminated, and can configure the additional dynamic information for the terminal in response to the second overheating assistance information.

In other implementations, for a terminal capable of knowing a running condition of the AI model of the terminal, the terminal may make some reasonable suggestions to the network side when the overheat of the terminal is alleviated or eliminated. Specifically, the terminal may make a suggestion to the network side through the suggestion information about an AI-model configuration in the reported second overheating assistance information. The terminal may indicate, to the network side through the suggestion information about an AI-model configuration, one or more of: a suggested AI model to be turned on, or a suggested AI model with improved accuracy. The network side may configure the additional dynamic information for the terminal by considering the suggestion information about an AI-model configuration, so as to improve the matching between the additional dynamic information configured for the terminal and the actual requirement of the terminal, and help to ensure the communication performance of the terminal.

In still other implementations, for a terminal that has limited capability and is unable to provide reasonable suggestions to the network side, the terminal can calculate available calculation resources at the current moment, and predicted available calculation resources which do not cause overheat, etc., and report the second overheating assistance information including one or more of: the available calculation resources at the current moment, or the predicted available calculation resources which do not cause overheat, etc. After receiving the second overheating assistance information, the network side may accurately obtain the available calculation resource information of the terminal. Thus, the network side can determine how to configure appropriate additional dynamic information for the terminal by comprehensively considering one or more of: the available calculation resources of the terminal, an air interface, a base station, a capability reported by a neighboring cell, historical additional dynamic information that has been configured for the terminal, or the like.

It should be noted that, the second overheating assistance information, reported by the terminal according to an actual requirement of the terminal, an actual capability of the terminal, and the like, may include two or all of: second overheating assistance indication information, suggestion information about an AI-model configuration, and available calculation resource information, which are not elaborated herein.

In some implementations, when the overheat is detected by the terminal to be alleviated or eliminated and the terminal is in an idle state or an inactivated state currently, the terminal establishes a connection with the network side. After establishing the connection with the network side, the terminal reports the second overheating assistance information.

Another method for processing overheat is provided in implementations of the present disclosure, which can be performed by the network side. The method for processing overheat can specifically include sending configuration indication information to a terminal, to make the terminal adjust a working state of a corresponding AI model based on the configuration indication information when the terminal is overheated. The configuration indication information is indicative of a working-state configuration of the AI model. Therefore, when the terminal is overheated, the working state of the corresponding AI model can be adjusted based on the configuration indication information. For example, some AI models are turned off and accuracy of some AI models are adjusted, etc., such that the overheat of the terminal is expected to be alleviated or eliminated.

In a specific implementation, the configuration indication information is pre-configured static information, that is, the network side may pre-configure the static information, and send the pre-configured static information to the terminal.

The static information may include configuration permission information about the AI model, and the configuration permission information about the AI model is indicative of a configuration permission for the AI model.

The network side may pre-configure the static information when configuring the AI model or updating the AI model for the terminal.

In a specific implementation, for the description of the static information, reference may be made to the descriptions in the foregoing implementations of the present disclosure, which will not be repeatedly described herein.

In a specific implementation, the configuration indication information may include dynamic information, where the dynamic information is configured when the terminal is overheated. The dynamic information is indicative of a working-state configuration of an AI model when the terminal is overheated, and the configuration indication information includes the dynamic information.

After configuring the dynamic information, the network side may send the dynamic information to the terminal.

In some implementations, the network side may send the configuration indication information including the dynamic information to the UE via RRC signaling.

In a specific implementation, the dynamic information may include at least one of: an AI model to be kept on, an AI model to be turned off, an off duration of an AI model, an AI model with reduced accuracy, a duration during which accuracy of an AI model is to be reduced, or the like.

In a specific implementation, the terminal reports the first overheating assistance information to the network side in response to detecting overheat, and the network side may configure the dynamic information when receiving the first overheating assistance information.

In a specific implementation, the first overheating assistance information may include at least one of: first overheating indication information, suggestion information about an AI-model configuration, available calculation resource information, etc.

For the first overheating assistance information, reference may be made to the relevant descriptions of the first overheating assistance information in the foregoing implementations of the present disclosure, which will not be described herein.

In some implementations, the network side may configure the dynamic information for the terminal in real time based on the first overheating assistance information and send the dynamic information to the terminal. Thus, the dynamic information configured for the terminal each time can meet a current practical condition of the terminal.

In other implementations, the network side may also select one configuration from multiple preset configurations based on a mapping relationship configured in a mapping table based on a pre-configured policy and mapping relationships. Different configurations correspond to different working state configurations of the AI model, dynamic information is generated based on the selected configuration, and sent to the terminal. For example, the overheat caused by different AI models correspond to different configurations, or different types of terminals correspond to different configurations. It can be understood that corresponding configurations can also be determined on the basis of other factors, and the corresponding configuration can be selected on the basis of current practical requirements during subsequent use.

In a specific implementation, when the overheat of the terminal is alleviated or eliminated, the network side can configure the additional dynamic information for the terminal. The additional dynamic information is indicative of the working-state configuration of the AI model when the overheat of the terminal is alleviated or eliminated. The network side sends the additional dynamic information to the terminal, and the terminal re-adjusts a working state of a corresponding AI model based on the additional dynamic information.

The additional dynamic information may include at least one of: an AI model to be tuned on, or an AI model with improved accuracy.

In a specific implementation, when detecting the overheat is alleviated or eliminated, the terminal may report second overheating assistance information to the network side. The network side configures the additional dynamic information when receiving the second overheating assistance information, and sends the configured additional dynamic information to the terminal.

In a specific implementation, the network side can send the additional dynamic information to the terminal through RRC signaling.

In a specific implementation, for a specific working process, a working principle, and an interaction process with the terminal of the method for processing overheat performed by the network side, reference may be made to related descriptions in the method for processing overheat performed by the terminal provided in the foregoing implementations, which will not be repeatedly described herein.

In some non-limiting implementations, the dynamic information can further include static information, and the static information includes configuration permission information about the AI model. The configuration permission information about the AI model is indicative of a configuration permission for the AI model. In this case, the terminal may configure the working state of the AI model based on a working-state configuration of the AI model when the terminal is overheated indicated in the dynamic information. The static information may be stored locally in the terminal, and when the terminal is overheated subsequently, the terminal may independently decide to adjust the working state of the AI model based on the configuration permission information about the AI model in the static information. The static information may also be used for the terminal to re-adjust the working state of the AI model based on the configuration permission information about the AI model in the static information when the overheat of the terminal is alleviated or eliminated.

For specific implementations of adjusting the working state of the AI model by the terminal based on the static information, reference may be made to related descriptions of the static information in the foregoing implementations of the present disclosure, which will not be repeatedly described herein.

In a specific implementation, when the terminal is overheated for the first time, or the number of times that the terminal is overheated exceeds a set number of times, the network side may add static information to the dynamic information, so as to indicate the configuration permission for the AI model to the terminal. When the terminal is overheated subsequently, the terminal may independently determine how to adjust the working state of the AI model based on the configuration permission for the AI model indicated in the static information without interacting with the network side, thereby improving overheat processing efficiency.

It should be noted that, the AI model in the foregoing implementation of the present disclosure may be a model having an AI-enabled network function in the terminal, so as to facilitate development of a communication network in an automation and intellectualization direction.

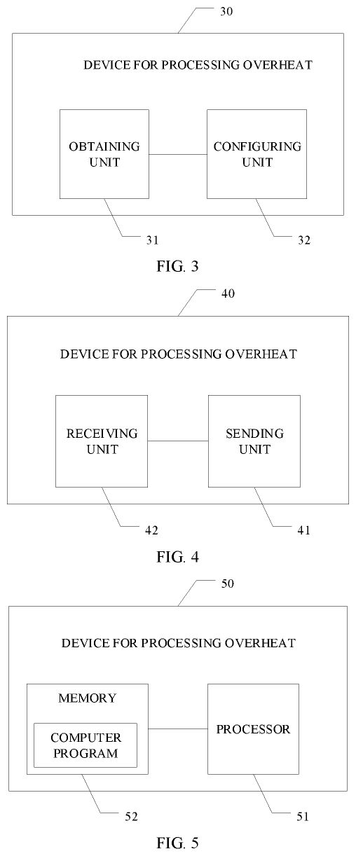

A device for processing overheat is further provided in implementations of the present disclosure. The device for processing overheat may be applied to a terminal, and may also be applied to some chips or other components. Referring to FIG. 3, which is a schematic structural diagram of a device for processing overheat in some implementations of the present disclosure. The device 30 for processing overheat may include an obtaining unit 31 and a configuring unit 32.

The obtaining unit 31 is configured to obtain configuration indication information in response to detecting overheat of a terminal, where the configuration indication information is indicative of a working-state configuration of an AI model. The configuring unit 32 is configured to a working state of a corresponding AI model based on the configuration indication information

In a specific implementation, for a working principle and a working process of the device 30 for processing overheat, reference may be made to descriptions of the method for processing overheat illustrated in FIGS. 1 and 2 provided in the foregoing implementations of the present disclosure, which are not repeated herein.

In a specific implementation, the described device 30 for processing overheat may be a chip having an overheat processing function in the terminal (also referred to as the UE); or a chip having a data processing function, such as a baseband chip, or a chip module including a chip having an overheat processing function in the UE; or a chip module including a chip having a data processing function, or a UE.

In a specific implementation, the modules/units included in the apparatuses and products described in the foregoing implementations may be software modules/units, or may be hardware modules/units, or may be software modules/units in part, or may be hardware modules/units in part.

For example, for each device and product applied to or integrated into the chip, each module/unit included can be implemented by hardware such as circuits, or at least part of modules/units can be implemented by software programs that run on a processor integrated into the chip, and the rest of modules/units can be implemented by hardware such as circuits. For each device and product applied to or integrated into the chip module, each module/unit included can be implemented by hardware such as circuit, and different modules/units can be located in a same component (such as a chip, a circuit module, etc.) or different components of the chip module. Alternatively, at least part of modules/units can be implemented by software programs that run on the processor integrated into the chip module, and the rest of modules/units can be implemented by hardware such as circuits. For each device and product applied to or integrated into the UE, each module/unit included can be implemented by hardware such as circuits, and different modules/units can be located in the same component (e.g., a chip, a circuit module, etc.) or different components in the terminal device, or at least part of modules/units can be implemented by software programs that run on the processor integrated into the UE, and the rest of modules/units can be implemented by hardware such as circuits.

Another device for processing overheat is further provided in implementations of the present disclosure. The device for processing overheat may be applied to a network side. Referring to FIG. 4, which is a schematic structural diagram of a device for processing overheat in an implementation of the present disclosure, the device 40 for processing overheat may include a sending unit 41. The sending unit 41 is configured to configured to send configuration indication information to a terminal, to make the terminal adjust a working state of a corresponding AI model based on the configuration indication information when the terminal is overheated, where the configuration indication information is indicative of a working-state configuration of the AI model.

In a specific implementation, the device 40 for processing overheat can further include a receiving unit 42, and the receiving unit 42 may be configured to receive assistance information reported by the terminal.

In some implementations, the assistance information reported by the terminal may include first overheating assistance information, and the first overheating assistance information is reported when the terminal is overheated. The device 40 for processing overheat may generate the configuration indication information including the dynamic information based on the first overheat assistance information.

In other implementations, the assistance information reported by the terminal may include second overheating assistance information, and the second overheating assistance information is reported when the overheat of the terminal is alleviated or eliminated. The device 40 for processing overheat may generate additional dynamic information based on the second overheat assistance information, and may transmit the second overheat assistance information to the terminal through the transmitting unit 41.

In a specific implementation, for a working principle and working process of the device 40 for processing overheat, reference may be made to the descriptions of the method for processing overheat on the network side provided in the described implementations of the present disclosure, which will not be repeated herein.

A storage medium is further provided in implementations of the present disclosure. The storage medium is a non-volatile storage medium or a non-transitory storage medium, and the storage medium is configured to store a computer program. The computer program, when executed by a processor, is operable with the processor to perform the method for processing overheat provided in any one of the foregoing implementations.

A device 50 for processing overheat is further provided in implementations of the present disclosure. The device 50 includes a memory 52 and a processor 51. The memory 52 is configured to store a computer program capable of running on the processor 51, and the processor 51, when running the computer program, is configured to perform the method for processing overheat according to any one of the foregoing implementations.

It should be noted that specific implementations have been described above, but these implementations are not intended to limit the scope of the present disclosure, even if only a single implementation is described with respect to specific features. Examples of features provided in the present disclosure are intended to be illustrative, but not limiting, unless otherwise defined. In specific implementations, technical features of one or more dependent claims may be combined with technical features of independent claims according to actual requirements and in technically feasible situations, and technical features from corresponding independent claims may be combined in any appropriate manner, rather than merely by specific combinations enumerated in the claims.

Persons of ordinary skill in the art should understand that all or part of operations of the methods in implementations of the present disclosure may be implemented by a program instructing relevant hardware. The program may be stored in any computer-readable storage medium. The storage medium may include a read-only memory (ROM), a random access memory (RAM), a magnetic disk, or an optical disk.

Although the present disclosure has been described above, the present disclosure is not limited thereto, and various changes and modifications can be made by those skilled in the art without departing from the spirit and scope of the present disclosure. Therefore, the scope of the present disclosure should be defined by the appended claims.

1. A method for processing overheat, comprising:
obtaining configuration indication information in response to detecting overheat of a terminal, wherein the configuration indication information is indicative of a working-state configuration of an AI model; and
adjusting a working state of a corresponding AI model based on the configuration indication information.

2. The method for processing overheat of claim 1, wherein the configuration indication information is static information pre-configured by the network side, and obtaining the configuration indication information in response to detecting the overheat of the terminal comprises:
in response to detecting the overheat of the terminal, obtaining static information pre-configured by the network side from the terminal, wherein the static information comprises configuration permission information about the AI model, and the configuration permission information about the AI model is indicative of a configuration permission for the AI model.

3. The method for processing overheat of claim 2, further comprising:
after adjusting the working state of the AI model is adjusted,
re-adjusting the working state of the AI model based on the configuration permission information about the AI model in response to detecting that the overheat of the terminal is alleviated or eliminated.

4. The method for processing overheat of claim 1, wherein obtaining the configuration indication information in response to detecting the overheat of the terminal comprises:
obtaining dynamic information configured by the network side from the network side in response to detecting the overheat of the terminal, wherein the dynamic information is indicative of the working-state configuration of the AI model when the terminal is overheated, and the configuration indication information comprises the dynamic information.

5. The method for processing overheat of claim 4, wherein obtaining the configuration indication information in response to detecting the overheat of the terminal comprises:
in response to detecting the overheat of the terminal, reporting first overheating assistance information to the network side, to make the network side send the dynamic information after receiving the first overheating assistance information.

6. The method for processing overheat of claim 5, wherein the first overheating assistance information comprises at least one of: first overheating indication information, suggestion information about an AI-model configuration, or available calculation resource information.

7. The method for processing overheat of claim 6, wherein the first overheating indication information is indicative of the overheat of the terminal, and the overheat of the terminal is related to running of the AI model, or
the suggestion information about the AI-model configuration comprises at least one of: a suggested AI model to be retained, a suggested AI model to be tuned off, a suggested off duration of an AI model, a suggested AI model with reduced accuracy, or a suggested duration during which accuracy of an AI model is to be reduced; or
the available calculation resource information comprises at least one of: available calculation resources at a current moment or predicted calculation resources to be reduced to alleviate overheat or eliminate overheat.

8. (canceled)

9. The method for processing overheat of claim 6, wherein the suggestion information about the AI-model configuration is obtained by:
determining the suggestion information about the AI-model configuration based on at least one of: configuration information about a historical AI model, calculation resources occupied by each running AI model, and predicted calculation resources to be reduced to alleviate overheat or eliminate overheat.

10. (canceled)

11. The method for processing overheat of claim 4, further comprising:
obtaining additional dynamic information configured by the network side from the network side in response to detecting that the overheat of the terminal is alleviated or eliminated, wherein the additional dynamic information is indicative of a working-state configuration of an AI model when the overheat of the terminal is alleviated or eliminated; and
re-adjusting the working state of the AI model based on the additional dynamic information.

12. The method for processing overheat of claim 11, wherein obtaining the additional dynamic information configured by the network side from the network side in response to detecting that the overheat of the terminal is alleviated or eliminated comprises:
reporting second overheating assistance information to the network side in response to detecting that the overheat of the terminal is alleviated or eliminated, to make the network side send the additional dynamic information after receiving the second overheating assistance information.

13. The method for processing overheat of claim 12, wherein the second overheating assistance information comprises at least one of: second overheating indication information, suggestion information about an AI-model configuration, and available calculation resource information.

14. The method for processing overheat of claim 13, wherein the second overheating indication information is indicative of alleviation or elimination of overheat.

15. The method for processing overheat of claim 13, wherein the suggestion information about the AI-model configuration comprises at least one of: a suggested AI model to be turned on, or a suggested AI model with improved accuracy.

16. The method for processing overheat of claim 13, wherein the suggestion information about the AI-model configuration is obtained by:
determining the suggestion information about the AI-model configuration based on at least one of: configuration information about a historical AI model, calculation resource occupied by each running AI model, and predicted available calculation resources which do not cause overheat.

17. The method for processing overheat of claim 13, wherein the available calculation resource information comprises at least one of: available calculation resources at a current moment, and predicted available calculation resources which do not cause overheat.

18. The method for processing overheat of claim 5, wherein the first overheating assistance information is reported to the network side through RRC signaling.

19. The method for processing overheat of claim 4, further comprising:
establishing a connection with the network side in response to detecting the terminal is overheated and currently in an idle state or an inactive state.

20. The method for processing overheat of claim 4, wherein the dynamic information further comprises static information, the static information comprises configuration permission information about the AI model, and the configuration permission information about the AI model is indicative of a configuration permission for the AI model.

21-34. (canceled)

35. A storage medium, the storage medium being a non-volatile storage medium or a non-transitory storage medium, wherein the storage medium is configured to store a computer program which, when executed by a processor, is operable with the processor to perform:
obtaining configuration indication information in response to detecting overheat of a terminal, wherein the configuration indication information is indicative of a working-state configuration of an AI model; and
adjusting a working state of a corresponding AI model based on the configuration indication information.

36. A device for processing overheat, comprising a memory and a processor, wherein the memory is configured to store a computer program capable of running on the processor, and the processor, when running the computer program, is configured to perform:
obtaining configuration indication information in response to detecting overheat of a terminal, wherein the configuration indication information is indicative of a working-state configuration of an AI model; and
adjusting a working state of a corresponding AI model based on the configuration indication information.
